(19) United States
(12) Patent Application Publication
(10) Pub. No.: US 2019/0385804 A1
(43) Pub. Date: Dec. 19, 2019

(54) CONTACTOR ASSEMBLY AND CONTACTOR TRANSITIONING METHOD

(71) Applicant: Ford Global Technologies, LLC, Dearborn, MI (US)

(72) Inventor: Wesley Burkman, Dearborn, MI (US)

(21) Appl. No.: 16/012,192

(22) Filed: Jun. 19, 2018

(51) Int. Cl. H01H 50/54; H01H 1/50; H01H 3/00; H01H 3/28; H01H 3/40

(52) U.S. Cl. CPC H01H 50/546; H01H 1/50; H01H 3/40; H01H 3/28; H01H 3/001

(57) ABSTRACT

An exemplary contactor assembly includes, among other things, a movable contact that transitions relative to a plurality of stationary contacts back and forth between a closed position and an open position. The movable contact contacts at least one of the stationary contacts with an initial contact surface and then a final contact surface when the movable contact is in the closed position. An exemplary contactor transitioning method includes, among other things, changing areas of contact between a movable contact and a plurality of stationary contacts when the movable contact is in a closed position with the plurality of stationary contacts.

### TECHNICAL FIELD

This disclosure relates generally to a contactor assembly and, more particularly, to a movable contact that can move relative to a stationary contact when in a closed position. The movement can inhibit a weld from forming between the movable contact and the stationary contact.

### BACKGROUND

Generally, electrified vehicles differ from conventional motor vehicles because electrified vehicles are selectively driven using one or more battery-powered electric machines. Conventional motor vehicles, in contrast to electrified vehicles, are driven exclusively with an internal combustion engine. Electrified vehicles may use electric machines instead of, or in addition to, the internal combustion engine.

Example electrified vehicles include hybrid electric vehicles (HEVs), plug-in hybrid electric vehicles (PHEVs), fuel cell vehicles, and battery electric vehicles (BEVs). A powertrain for an electrified vehicle can include a high-voltage battery pack having battery cells that store electric power for powering the electric machines and other electrical loads of the electrified vehicle.

A contactor assembly can be closed and opened to control a flow of electric power to and from the high-voltage battery pack. When a contactor assembly closes a circuit, uncharged load capacitance can cause an inrush current. Although relatively brief, the inrush current can cause portions of the contactor assembly to weld together.

### SUMMARY

A contactor assembly according to an exemplary aspect of the present disclosure includes, among other things, a movable contact that transitions relative to a plurality of stationary contacts back and forth between a closed position and an open position. The movable contact contacting at least one of the stationary contacts with an initial contact surface and then a final contact surface when the movable contact is in the closed position.

In another example of the foregoing contactor assembly, the initial contact surface resides in a first plane, and the final contact surface resides in a second plane that is transverse to the first plane.

In another example of any of the foregoing contactor assemblies, the movable contact includes an attachment section disposed between a first tab and a second tab relative to a longitudinal axis of the movable contact.

In another example of any of the foregoing contactor assemblies, the first and second tabs are tilted about the longitudinal axis of the movable contact relative to the attachment section.

In another example of any of the foregoing contactor assemblies, the first tab contacts a first one of the stationary contacts and the second tab contacts a second one of the stationary contacts when the movable contact is in the closed position.

Another example of any of the foregoing contactor assemblies includes a first and second tab of the movable contact. The initial contact surface is a first initial contact surface of the first tab. The final contact surface is a first final contact surface of the first tab. The movable contact further includes a second initial contact surface and a second final contact surface of the second tab.

In another example of any of the foregoing contactor assemblies, an actuator assembly engages the movable contact. The actuator assembly transitions the movable contact back and forth between the closed position and the open position.

In another example of any of the foregoing contactor assemblies, the actuator assembly extends through an aperture in the movable contact.

In another example of any of the foregoing contactor assemblies, the aperture is an ellipse having a first diameter and a second diameter that is less than the first diameter. The second diameter is aligned with the longitudinal axis.

In another example of any of the foregoing contactor assemblies, the movable contact is configured to rotate relative to the actuator assembly about a longitudinal axis of the movable contact when the movable contact is in the closed position.

In another example of any of the foregoing contactor assemblies, the movable contact in the closed position electrically couples a battery pack of an electrified vehicle to another portion of the electrified vehicle, and the movable contact in the open position electrically decouples the battery pack from the other portion of the electrified vehicle.

A contactor transitioning method according to another exemplary aspect of the present disclosure includes, among other things, changing areas of contact between a movable contact and a plurality of stationary contacts when the movable contact is in a closed position with the plurality of stationary contacts.

Another example of the foregoing method includes transitioning the movable contact from the closed position to an open position with a plurality of stationary contacts.

Another example of any of the foregoing methods includes, when the movable contact is in the closed position, contacting the plurality of stationary contacts with initial contact surfaces of the movable contact, and then contacting the plurality of stationary contacts with final contact surfaces.

In another example of any of the foregoing methods, the initial contact surfaces reside in respective first planes, and the final contact surfaces reside in respective second planes that are transverse to the first planes.

Another example of any of the foregoing methods includes rotating the movable contact relative to the stationary contacts during the changing.

In another example of any of the foregoing methods, the rotating is about a longitudinal axis of the movable contact.

Another example of any of the foregoing methods includes using an actuator assembly to transition the movable contact back and forth between the closed position and an open position, and rotating the movable contact relative to the actuator assembly during the changing.

Another example of any of the foregoing methods includes transitioning the contact bar from the closed position to an open position to electrically decouple a battery pack of an electrified vehicle from another portion of the electrified vehicle

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of a powertrain of an electrified vehicle.

FIG. 2 illustrates a contactor assembly of the powertrain of FIG. 1 when in an open, electrically decoupled position.

FIG. 3 illustrates a perspective view of a movable contact of the contactor assembly of FIG. 2.

FIG. 4 illustrates an end view of the movable contact of FIG. 3.

FIG. 5 illustrates a close-up view of the movable contact within the contactor assembly in the open position.

FIG. 6 illustrates a side view of selected portions of FIG. 5.

FIG. 7 illustrates a close-up view of the movable contact within the contactor assembly in an initial closed position.

FIG. 8 illustrates a side view of selected portions of FIG. 7.

FIG. 9 illustrates a close-up view of the movable contact within the contactor assembly in a final closed position.

FIG. 10 illustrates a side view of selected portions of FIG. 9.

FIG. 11 illustrate a top view of a movable contact for use in the contactor assembly of FIG. 2 according to another exemplary aspect of the present disclosure.

### DETAILED DESCRIPTION

This disclosure details exemplary embodiments of a contactor assembly.

The contactor assembly, in particular, includes a movable contact and stationary contact. The moveable contact and stationary contact can move relative to each other when in a closed position. The movement can inhibit a weld from forming between the movable contact and the stationary contact. In some examples, the moveable contact and stationary contact move linearly and rotationally relative to each other.

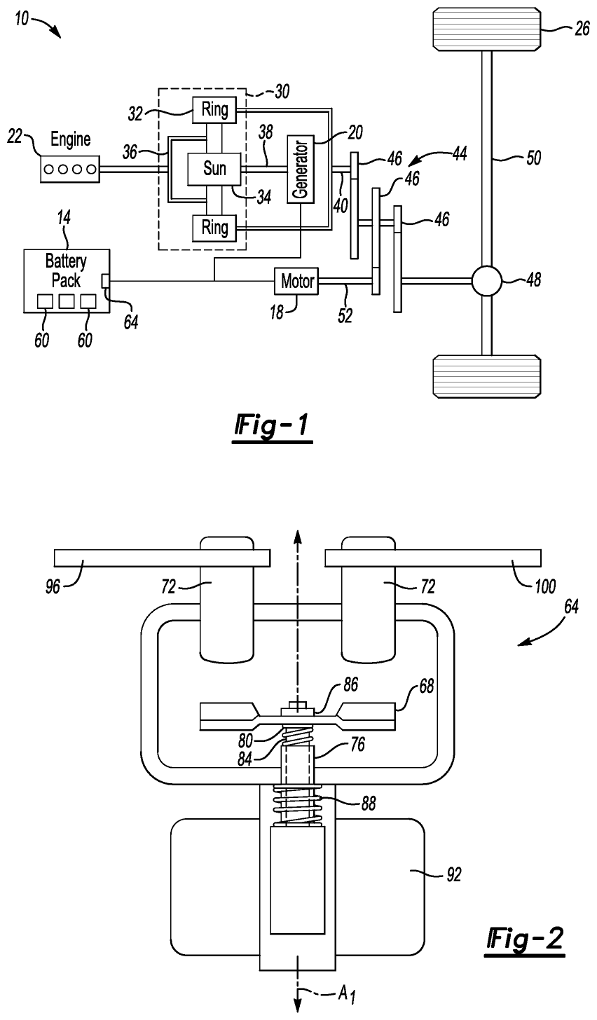

FIG. 1 schematically illustrates a powertrain 10 for an electrified vehicle, which is a hybrid electric vehicle (HEV) in this example. Although depicted as an HEV, it should be understood that the concepts described herein are not limited to HEVs and could extend to other types of electrified vehicle, including, but not limited to, plug-in hybrid electric vehicles (PHEVs), battery electric vehicles (BEVs), fuel cell vehicles, etc.

The powertrain 10 includes a battery pack 14, a motor 18, a generator 20, and an internal combustion engine 22. The motor 18 and generator 20 are types of electric machines. The motor 18 and generator 20 may be separate or may have the form of a combined motor-generator.

In this embodiment, the powertrain 10 is a power-split powertrain system that employs a first drive system and a second drive system. The first and second drive systems generate torque to drive one or more sets of vehicle drive wheels 26 of the electrified vehicle. The first drive system includes a combination of the engine 22 and the generator 20. The second drive system includes at least the motor 18, the generator 20, and the battery pack 14. The motor 18 and the generator 20 are portions of an electric drive system of the powertrain 10.

The engine 22, which is an internal combustion engine in this example, and the generator 20 may be connected through a power transfer unit 30, such as a planetary gear set. Of course, other types of power transfer units, including other gear sets and transmissions, could be used to connect the engine 22 to the generator 20. In one non-limiting embodiment, the power transfer unit 30 is a planetary gear set that includes a ring gear 32, a sun gear 34, and a carrier assembly 36.

The generator 20 can be driven by engine 22 through the power transfer unit 30 to convert kinetic energy to electrical energy. The generator 20 can alternatively function as a motor to convert electrical energy into kinetic energy, thereby outputting torque to a shaft 38 connected to the power transfer unit 30. Because the generator 20 is operatively connected to the engine 22, the speed of the engine 22 can be controlled by the generator 20.

The ring gear 32 of the power transfer unit 30 can be connected to a shaft 40, which is connected to vehicle drive wheels 26 through a second power transfer unit 44. The second power transfer unit 44 may include a gear set having a plurality of gears 46. Other power transfer units may also be suitable.

The gears 46 transfer torque from the engine 22 to a differential 48 to ultimately provide traction to the vehicle drive wheels 26. The differential 48 may include a plurality of gears that enable the transfer of torque to the vehicle drive wheels 26. In this example, the second power transfer unit 44 is mechanically coupled to an axle 50 through the differential 48 to distribute torque to the vehicle drive wheels 26.

The motor 18 can also be employed to drive the vehicle drive wheels 26 by outputting torque to a shaft 52 that is also connected to the second power transfer unit 44. In one embodiment, the motor 18 and the generator 20 cooperate as part of a regenerative braking system in which both the motor 18 and the generator 20 can be employed as motors to output torque. For example, the motor 18 and the generator 20 can each output electrical power to the battery pack 14.

The battery pack 14 provides a relatively high-voltage battery that can store generated electrical power and can output electrical power to operate the motor 18, the generator 20, or both.

The exemplary battery pack 14 provides a relatively high-voltage battery that can store generated electrical power and can output electrical power to operate the motor 18, the generator 20, or both. Arrays 60 of individual battery cells can be held within the battery pack 14 to store electrical power.

Referring now to FIG. 2 with continuing reference to FIG. 1, a contactor assembly 64 can be disposed within the battery pack 14. Although one contactor assembly 64 is shown, more than one of the contactor assembly 64 could be used, as required.

The contactor assembly 64 can transition from the open position of FIG. 2 to a closed position where the battery pack 14 is electrically coupled, through the contactor assembly 64, to other portions of the powertrain 10. The battery pack 14 is electrically decoupled from the other portions of the powertrain 10 when the contactor assembly 64 is in the open position.

In some examples, the contactor assembly 64 is transitioned to the open position when a vehicle having the powertrain 10 is faulted or the vehicle is turned off. The contactor assembly 64 can be, for example, be transitioned to the open position when a worker is performing maintenance of the powertrain 10 or another area of the vehicle. Transitioning the contactor assembly 64 to the open position can reduce a likelihood of exposing the worker to the relatively high-voltages of the battery pack 14.

Although, in this example, the contactor assembly 64 is shown within the battery pack 14, other positions are possible. For example, the contactor assembly 64 could be positioned outside the battery pack 14. When outside the battery pack 14, the contactor assembly 64 in the open position still electrically decouples the battery pack 14 from other portions of the powertrain 10, and the contactor assembly 64 in the closed position still electrically couples the battery pack 14 to the other portions of the powertrain 10.

The example contactor assembly 64 is a relatively high-voltage, high-power contactor assembly, such as 1 Form X type contactor assembly. Other examples could use other types of contactor assemblies.

The contactor assembly 64 includes, among other things, a movable contact 68, a plurality of stationary contacts 72, and an actuator assembly 76. The actuator assembly 76 is configured to transition the movable contact 68 back and forth along an axis A₁ between the open position of FIG. 2 and the closed position where the movable contact 68 contacts the stationary contacts 72.

In the open position, the movable contact 68 is spaced from the stationary contacts 72 and electrically decoupled from the contacts. In the closed position, at least some portion of the movable contact 68 contacts the stationary contacts 72 and is electrically coupled to the stationary contacts 72.

The movable contact 68 is secured to the actuator assembly 76. The actuator assembly 76 and the movable contact 68 are biased toward the closed position utilizing a contact spring 80 distributed annularly about a portion of a shaft 84 of the actuator assembly 76. The contact spring 80 is a coil spring in this example. In some examples, a retainer clip 86 can be secured within a groove at an end portion of the shaft 84 to prevent the contact spring 80 from forcing the movable contact 68 off the shaft 84.

The actuator assembly 76 is biased toward the open position utilizing a return spring 88 distributed annularly about a portion of the shaft 84 of the actuator assembly 76. The return spring 88 is a coil spring in this example. The return spring 88 can be about a portion of the shaft 84 having an increased diameter relative to the portion of the shaft 84 received within the contact spring 80. The shaft 84 moves back and forth with the movable contact 68 along the axis A₁.

In this example, a coil winding 92 can be energized to linearly move the shaft 84 along the axis A₁ to overcome the biasing force applied by the return spring 88 and move the movable contact 68 toward the stationary contacts 72, which transitions the contactor assembly 64 from the open position to the closed position. The coil winding 92 can be a solenoid that, when charged, acts as an electromagnet to pull the shaft 84, and thus the movable contact 68, along the axis A toward from the stationary contacts 72.

When the contactor assembly 64 is in the closed position where the movable contact 68 contacts the stationary contacts 72, current can pass from a busbar 96, through one of the stationary contacts 72, through the movable contact 68, through the other one of the stationary contacts 72, and to another busbar 100.

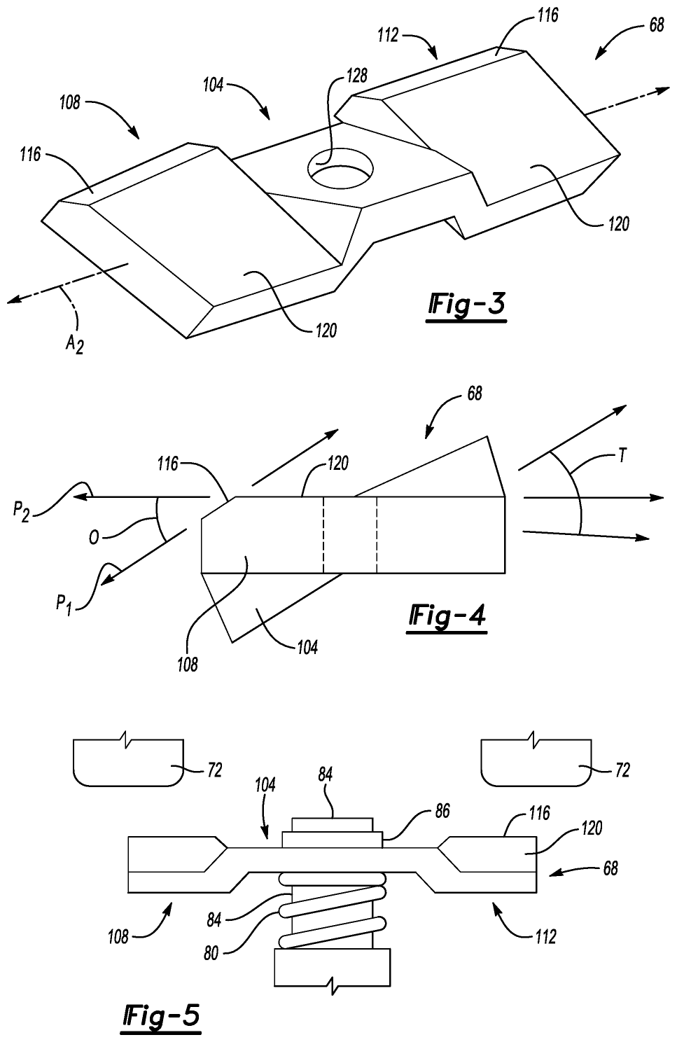

With reference now to FIG. 3, in an exemplary non-limiting embodiment of the present disclosure, the movable contact 68 includes an attachment section 104, a first tab 108, and a second tab 112. The attachment section 104 is disposed between the first tab 108 and the second tab 112 relative to a longitudinal axis A₂ of the movable contact 68.

The first tab 108 and the second tab 112 are tilted about the longitudinal axis A₂ relative to the attachment section 104. In this example, the angle of tilt T is about 30 degrees. Other angles are possible and fall within the scope of this disclosure.

The first tab 108 and the second tab 112 each include an initial contact surface 116 and a final contact surface 120. In this example, the initial contact surfaces 116 reside in a first plane P₁ and the final contact surface reside in a second plane P₂. The first plane P₁ is transverse to the second plane P₂. In this example, the first plane P₁ has an offset O of about 45 degrees from the second plane P₂. Other offsets are possible and fall within the scope of this disclosure.

Further, although described as planar, the initial contact surface 116, the final contact surface 120, or both, could be rounded or have an otherwise nonplanar configuration.

Referring now to FIGS. 5-10 with continuing reference to FIGS. 3-4, the shaft 84 extends through an aperture 128 in the attachment section 104 to engage the movable contact 68 of the actuator assembly 76. The contact spring 80 clamps the attachment section 104 against the retainer clip 86 when the attachment section 104 and the movable contact 68 are engaged together.

The aperture 128 is oversized relative to a diameter of the shaft 84 to permit movement of the movable contact 68 relative to the shaft 84 about the longitudinal axis A₂ of the movable contact 68. Such movement can permit changing areas of contact between the movable contact 68 and the stationary contacts 72 when the movable contact 68 is in a closed position. Changing the areas of contact can help to avoid welding the movable contact 68 to one or more of the stationary contacts 72 due to inrush current.

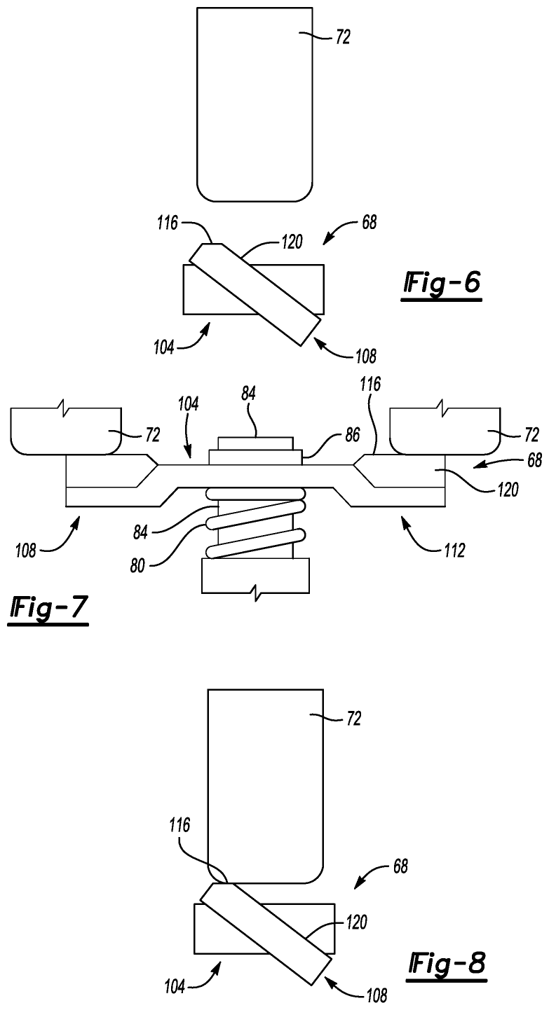

When the movable contact 68 is in the open position of FIGS. 5 and 6, the initial contact surfaces 116 are closer to the stationary contacts 72 than the final contact surfaces 120. Thus, as the movable contact 68 is transitioned along the axis A₁ from the open position of FIGS. 5 and 6 to the initial closed position of FIGS. 7 and 8, the initial contact surfaces 116 contact the stationary contacts 72 before other portions of the movable contact 68.

After the initial contact surfaces 116 contact the stationary contacts 72, the movable contact is in the initial closed position. When in the initial closed position, the initial contact surface 116 of the first tab 108 contacts one of the stationary contacts 72, and the initial contact surface 116 of the second tab 112 contacts another one of the stationary contacts 72. When the initial contact surfaces 116 contact the stationary contacts 72, a spike of inrush current can begin to pass between the stationary contacts 72 and the movable contact 68.

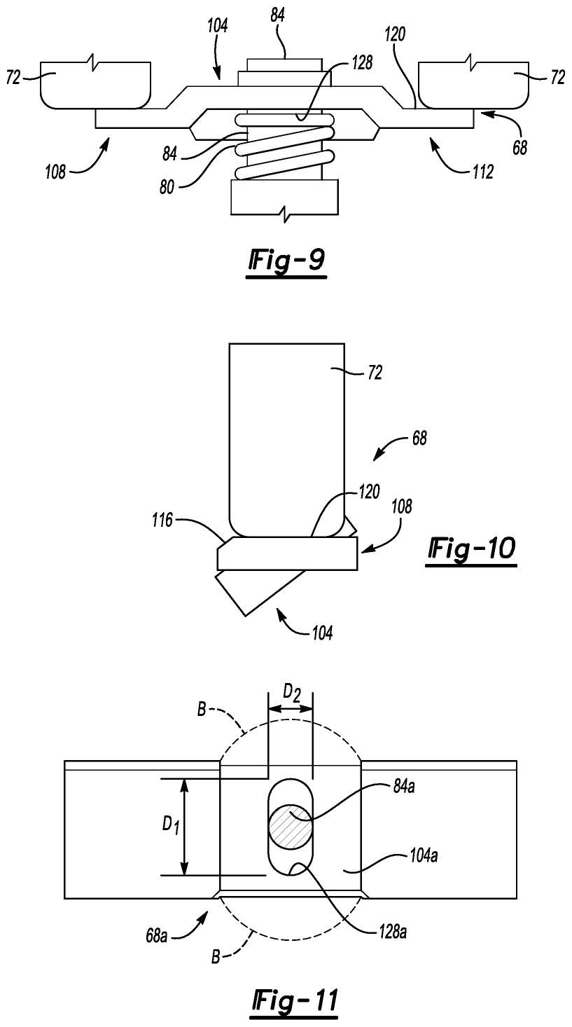

Continued movement of the movable contact 68 along the axis A₁ forces the movable contact 68 to rotate relative to the stationary contacts 72 about the axis A₂ until the movable contact 68 is in the final contact position of FIGS. 9 and 10. The relative rotation of the movable contact changes the areas of contact between the stationary contacts 72 and the movable contact 68. Thus, while the spike of inrush current can create molten metal where the initial contact surfaces 116 contact the stationary contacts 72, the relative rotation of the movable contact 68 disconnects the initial contact surfaces 116 from the stationary contacts 72 to inhibit the molten metal from solidifying into a weld. Even if a weld is created, the relative rotation of the movable contact 68 can increase a likelihood that the weld breaks or weakens.

In this example, the areas of contact change from the initial contact surfaces 116 to the final contact surfaces 120. Essentially, the initial contact surfaces 116 roll off the stationary contacts 72, and the final contact surfaces 120 roll into contact with the stationary contacts 72. When in the final closed position, the final contact surface 120 of the first tab 108 contacts one of the stationary contacts 72, and the final contact surface 120 of the second tab 112 contacts another one of the stationary contacts 72.

Changing the areas of contact shortens an amount of time that inrush current moves through directly contacting areas of the movable contact 68 and the stationary contacts 72. This can help to reduce the chance of welding the movable contact 68 to one or more of the stationary contacts 72. The transitioning of the movable contact 68 against the stationary contacts 72 is forceful enough to cause the rotation of the movable contact 68 about the axis A₂ even though the attachment section 104 is held between the retainer clip 86 and the contact spring 80. The rotation of the attachment section 104 can cause some areas of the attachment section 104 to rotate away from the retainer clip 86, which can compress the contact spring 80.

In this disclosure, like reference numerals designate like elements where appropriate, and reference numerals with the addition of “a” designate modified elements. The modified elements incorporate the same features and benefits of the corresponding modified elements, expect where stated otherwise.

With reference to FIG. 11, another example movable contact 68a includes an aperture 128a within an attachment section 104a. The aperture 128a is an ellipse having a first diameter D₁ and a second diameter D₂ that is less than the first diameter D₁. The second diameter D₂ is aligned, generally, with a longitudinal axis of the movable contact 68a. Making the diameter D₁ greater than the second diameter D₂ and greater than a diameter of a shaft 84a received within the aperture 128, can facilitate rotation of the movable contact 68a when the movable contact 68a is moved from an initial contact position to a final contact position with stationary contacts.

In some examples, the movable contact 68a could have an attachment section 104a that is widened relative to the first and second tabs. Exemplary areas that could be widened are shown as broken lines B in FIG. 11.

Widening the attachment section 104a can provide the movable contact 68a with a desired cross-sectional thickness while still providing the aperture 128 that is oversized relative to the diameter of the shaft 84a. The widening could also be used in connection with the movable contact 68 of the embodiments of FIGS. 2-10.

Features of the disclosed examples include a movable contact that changes an area of the contact with a stationary contact when the movable contact is in a closed position. Changing the area of contact during closing can cause continuing movement at the point of initial contact that endures the inrush current, which can reduce the likelihood of welding the movable contact to the stationary contact. Upon closure of the movable contact, there is little to no arcing between the stationary contact and the movable contact.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A contactor assembly, comprising:
a movable contact that transitions relative to a plurality of stationary contacts back and forth between a closed position and an open position, the movable contact contacting at least one of the stationary contacts with an initial contact surface and then a final contact surface when the movable contact is in the closed position.

2. The contactor assembly of claim 1, wherein the initial contact surface resides in a first plane, and the final contact surface resides in a second plane that is transverse to the first plane.

3. The contactor assembly of claim 1, wherein the movable contact includes an attachment section disposed between a first tab and a second tab relative to a longitudinal axis of the movable contact.

4. The contactor assembly of claim 3, wherein the first and second tabs are tilted about the longitudinal axis of the movable contact relative to the attachment section.

5. The contactor assembly of claim 3, wherein the first tab contacts a first one of the stationary contacts and the second tab contacts a second one of the stationary contacts when the movable contact is in the closed position.

6. The contactor assembly of claim 1, further comprising a first and second tab of the movable contact, the initial contact surface a first initial contact surface of the first tab, the final contact surface a first final contact surface of the first tab, wherein the movable contact includes a second initial contact surface and a second final contact surface of the second tab.

7. The contactor assembly of claim 1, further comprising an actuator assembly that engages the movable contact, the actuator assembly transitioning the movable contact back and forth between the closed position and the open position.

8. The contactor assembly of claim 7, wherein the actuator assembly extends through an aperture in the movable contact.

9. The contactor assembly of claim 8, wherein the aperture is an ellipse having a first diameter and a second diameter that is less than the first diameter, the second diameter aligned with the longitudinal axis.

10. The contactor assembly of claim 7, wherein the movable contact is configured to rotate relative to the actuator assembly about a longitudinal axis of the movable contact when the movable contact is in the closed position.

11. The contactor assembly of claim 1, wherein the movable contact in the closed position electrically couples a battery pack of an electrified vehicle to another portion of the electrified vehicle, and the movable contact in the open position electrically decouples the battery pack from the other portion of the electrified vehicle.

12. A contactor transitioning method, comprising:
changing areas of contact between a movable contact and a plurality of stationary contacts when the movable contact is in a closed position with the plurality of stationary contacts.

13. The contactor transitioning method of claim 12, further comprising transitioning the movable contact from the closed position to an open position with a plurality of stationary contacts.

14. The contactor transitioning method of claim 12, further comprising, when the movable contact is in the closed position, contacting the plurality of stationary contacts with initial contact surfaces of the movable contact, and then contacting the plurality of stationary contacts with final contact surfaces.

15. The contactor transitioning method of claim 14, wherein the initial contact surfaces reside in respective first planes, and the final contact surfaces reside in respective second planes that are transverse to the first planes.

16. The contactor transitioning method of claim 12, further comprising rotating the movable contact relative to the stationary contacts during the changing.

17. The contactor transitioning method of claim 16, wherein the rotating is about a longitudinal axis of the movable contact.

18. The contactor transitioning method of claim 12, further comprising using an actuator assembly to transition the movable contact back and forth between the closed position and an open position, and rotating the movable contact relative to the actuator assembly during the changing.

19. The contactor transitioning method of claim 12, further comprising transitioning the contact bar from the closed position to an open position to electrically decouple a battery pack of an electrified vehicle from another portion of the electrified vehicle.
